(19) United States
(12) Patent Application Publication
(10) Pub. No.: US 2011/0048181 A1
(43) Pub. Date: Mar. 3, 2011

(54) SCREW HEAD RECESS STRUCTURE AND ITS DRIVING TOOL

(75) Inventor: Chun-Hsin TSAI, Taipei Hsien (TW)

(73) Assignee: HAMA NAKA SHOUKIN INDUSTRY CO., LTD., Taipei Hsien (TW)

(21) Appl. No.: 12/548,940

(22) Filed: Aug. 27, 2009

(51) Int. Cl. B25B 23/00; F16B 23/00

(52) U.S. Cl. 81/460; 411/403

(57) ABSTRACT

A screw head recess structure and its driving tool that maximizes torque are provided, applicable to any kinds of rotational fasteners, such as screws or bolts. A recess has an irregular shape formed by a plurality of lobular grooves arranged around the center point of a fastener as an axis. A plurality of facets of corresponding grooves along both sides of central lines is formed that receive forces when the fastener rotates clockwise and anticlockwise. As a driving tool having a matching configuration with the recess structure rotates the recess, moment arms of forces and reaction forces exerted upon corresponding facets are on the same central lines, thus maximizing the torque generated by the driving tool. In addition to maximizing the torque, the recess structure is also special in that on which ordinary driving tools cannot operate, thereby protecting the fastener against unwanted disassembly. Moreover, the depth of the recess can be kept shallow since operation of which is effort-saving. This makes the present invention especially suitable for applications that require compact and light fasteners.

### FIELD OF THE INVENTION

The present invention relates to a screw head recess structure and its driving tool, and more particularly, to a recess for various kinds of rotational fasteners and the structure and design of a driving tool applicable to the fastener.

### BACKGROUND OF THE INVENTION

A rotation fastener, such as a screw or a bolt, usually has a particularly shaped recess arranged on the top face of its head for inserting driver bits of a driving tool, such as a screw driver, thereinto and applying forces in a clockwise or anticlockwise fashion in order to tighten or loosen the fastener with respect to an object.

Traditional recess shapes include, for example, linear, crossed, rectangular, or hexagonal shapes. Although such designs are widely used and easy to manufacture, they do not consider the effort required to fasten/unfasten and its convenience. Thus, they have limitations and they as well as their driving tools can be easily damaged. For example, a traditional fastener with a shallow linear recess has limited engaging area with the driver bits of the driving tool, when a greater force is applied, the driver bits may easily slip out of the recess, damaging the recess of the fastener and the driver bits of the driving tool, and the fastener cannot be securely fastened. Whereas for a fastener with deeper recess, such as a traditional screw with a cross-shaped recess, it is easier for the cross-shaped driving tool to locate in position, and provide a better torque with the greater engaging areas. However, when a force is applied, the driving tool may still slip out of the recess and damage the recess and the driver bits of the driving tool. In addition, a deeper recess design would also render a thicker head of the screw, and in turn, a bigger overall size of the screw. Furthermore, most designs focus on increasing the engaging areas of the recess and the driver bits of the driving tool, but ignore the fact that when a fastening tool rotates, force-receiving facets (points of application) on the recess has angular differences that result in moment arms that are not on the same central lines, and as a result, the torque generated by the driving tool is not at its maximum. Thus, one needs to exert a greater force to achieve the same fastening or unfastening effect.

Similar problems exist in several prior U.S. patents, for example, U.S. Pat. Nos. 7,077,038 and 7,150,211 and PCT Publication No. WO2008/136765, each discloses a screw head with a different recess pattern. However, they all have the same drawback in that torque cannot be filly maximized. In U.S. Pat. No. 7,077,038, a screw head recess is disclosed that includes a plurality of engaging grooves equiangularly radiating from an axis of the screw, wherein a bottom of each engaging grooves has rugged slopes for enlarging the engaging area of the engaging grooves with a screw driver bit. However, the moment arms of torques acted upon the disclosed recess are not on the same central line. In U.S. Pat. No. 7,150,211, a screw head recess is disclosed that includes three lobes evenly spaced around an axis of the screw, engaging lobes are circular in cross section and separated by curved drive flanges. The recess has a downward and inward curving slope along each lobe for enlarging the engaging area with a screw driver bit. Similarly, the moment arms of torques acted upon the disclosed recess are not on the same central line. In PCT Publication No. WO2008/136765, a screw head recess is disclosed that includes four semi-circular engaging grooves equally spaced around an axis of the screw. Each groove includes two side walls, a bottom and one inner wall, wherein the two symmetrical sidewalls have the same arc shape and the inner wall is a vertical wall that extends to the bottom for providing enough depth for the screw head recess to faithfully transmit the force of a screw driver. Similarly, the moment arms of torques acted upon the disclosed recess are not on the same central line.

Furthermore, abovementioned prior arts are common in that they have a deeper recess for enlarging the engaging area with a screw driver bit, but the larger the depth of the recess, the thicker it is. As a result, these kinds of screws are not suitable in cases that require compact and light screws, especially in cases that require precise miniature screws with high fastening quality.

Moreover, traditional screw recesses, such as linear- and cross-shape recesses, are widely used in the assembly of various machinery parts, and can be easily disassembled by ordinary screw drivers. Thus, they do not offer safety against unwanted disassembly.

### SUMMARY OF THE INVENTION

In the light of forgoing drawbacks, an objective of the present invention is to provide a screw head recess structure and its driving tool that maximizes the torque. Also, another objective of the present invention is to provide a fastener design that can be made small and light with a high fastening quality and a safety feature. The screw head recess structure has an irregular-shape recess provided on the head of a fastener formed by a plurality of lobular grooves, which arranged around the center point of the fastener as an axis on a top face of the fastener. Facets are formed at both sides of each groove that receive forces when the fastener rotates clockwise and anticlockwise, and the facets of corresponding grooves on both sides of grooves along a central line are in parallel with and on the same central line. As a driving tool having a matching configuration with the recess structure rotates the recess, driver bits of the driving tool create forces and reaction forces that are the same in magnitude but opposite in direction with respect to the facets at both sides of the grooves on the same central lines, thereby maximizing the torque generated when the driving tool rotates. By using the present invention, the following functions can be achieved:

1. Since each lobular groove of the recess according to the present invention has a facet that receives a force that is opposite in direction with respect to that on another lobular groove at the other side of the center point on the same central line when the driving tool applies, the facets receiving opposite forces generate a force couple, and because forces are exerted on the facets of the grooves along both sides of the same central lines, a maximum torque can be obtained. Accordingly, users can fasten the fastener with minimum effort and the fastening quality is enhanced.

2. Since the present invention provides a recess structure that brings the torque of the driving tool to full effectiveness, there is no need for a deep recess design to increase the contact area therebetween, thus the screw head can be thinned, and in turn the overall volume of the fastener can be reduced, which makes it suitable for applications that require compact and high fastening quality fasteners.

3. Since the recess structure has an uncommon configuration, ordinary driving tools cannot easily find a pivot inside the screw head recess structure, making it safe against unwanted disassembly and/or theft.

### BRIEF DESCRIPTION OF THE DRAWINGS

The present invention can be more fully understood by reading the following detailed description of the preferred embodiments, with reference made to the accompanying drawings, wherein:

FIG. 1 is a diagram depicting a bottom view of a screw head recess structure according to an embodiment of the present invention;

FIG. 2 is a diagram depicting a front cross-sectional view of the screw head recess structure of FIG. 1;

FIG. 3 is a diagram depicting a perspective view of a driving tool according to an embodiment of the present invention

FIG. 4 is a diagram depicting a top view of the driving tool;

FIG. 5 is a first diagram illustrating the act of combining the screw head recess structure and the driving tool; and

FIG. 6 is a second diagram illustrating the act of combining the screw head recess structure and the driving tool.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

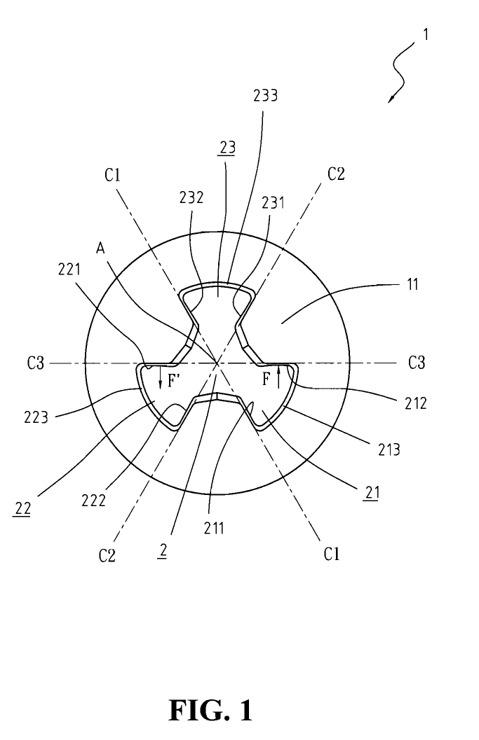

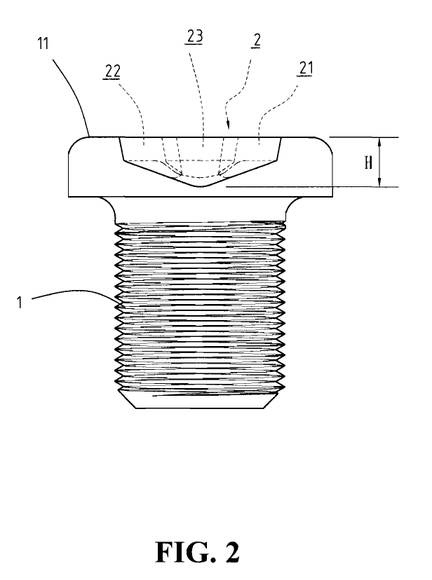

Referring to FIGS. 1 and 2, diagrams depicting bottom and front views of a screw head recess structure are shown. The screw head recess structure includes a head in any kind of rotational fastener, such as a screw, a bolt and etc., provided with a recess (2) comprised by a plurality of lobular grooves (21) (22) (23), wherein, in a preferred embodiment of the present invention, the three sets of grooves (21) (22) (23) of the recess (2) are arranged in a radiating manner equiangularly from an axis (A) of a fastener (1) on the top face (11) of the fastener (1). As seen from FIG. 1, the grooves (21) (22) (23) have an approximate “n” shape and are joined to each other forming a three-toe configuration, wherein the grooves (21) (22) (23) include respective facets (211) (212) (221) (222) (231) (232) at either side of the grooves that receive forces when the fastener (1) are turned clockwise or anticlockwise, and arc-shaped outer sidewalls (213) (223) (233). Each pair of facets (211) (212) (221) (222) (231) (232) gets closer to each other as they tend towards the axis of the fastener, so as to allow two symmetrical facets (211) (212) (221) (222) (231) (232) from different grooves (21) (22) (23) to align and in parallel with central lines (C1) (C2) (C3) of the axis (A). That is, the facet (211) of the groove (21) the facet (232) of another facet (23) are on the same central line (C1); the facet (222) of the groove (22) the facet (231) of another facet (23) are on the same central line (C2); and the facet (221) of the groove (22) the facet (212) of another facet (21) are on the same central line (C3).

Also shown in FIG. 2, the lobular grooves (21) (22) (23) of the recess (2) according to an embodiment of the present invention is slightly inclined downward from the top face (11) of the fastener (1) towards the central point at the bottom of the recess (2), allowing fast and convenient locating of the driving tool on the recess (2). In addition, the present invention provides a recess design for the fastener (1) that brings torque to its full effectiveness, the depth (H) of the recess (2) does not need to be very deep to obtain a large torque from a small applied force. Accordingly, the depth of the screw head recess described herein can be half that of a traditional one. Thus, the present invention is particularly suitable for fasteners that require high fastening quality in a limited space, such as a miniature screw.

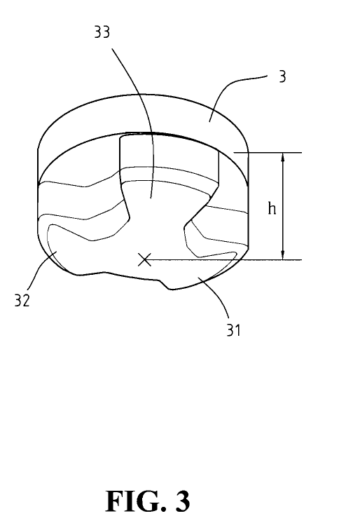

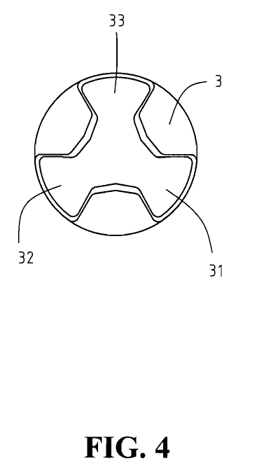

According to the above, a driving tool (3) is provided for use with the fastener (1) just mentioned to screw or unscrew the fastener (1). Referring to FIGS. 3 and 4, a driving tool (3) according to one embodiment of the present invention has a matching design with the recess (2) of the fastener (1), including three lobular driver bits (31) (32) (33) that match the three-toe grooves (21) (22) (23) of the recess (2). Similarly, the three driver bits (31) (32) (33) are equiangularly arranged and protruding from the tip of the driving tool (3) with height (h) substantially equal to the depth (H) of the recess (2) of the fastener (1), so that the driver bits (31) (32) (33) can fully fit into the recess (2) for rotational operations. The three equiangularly arranged driver bits (31) (32) (33) can be randomly insert into the three-lobe recess (2), since both have the same configurations. This makes the driving tool (3) easier to use.

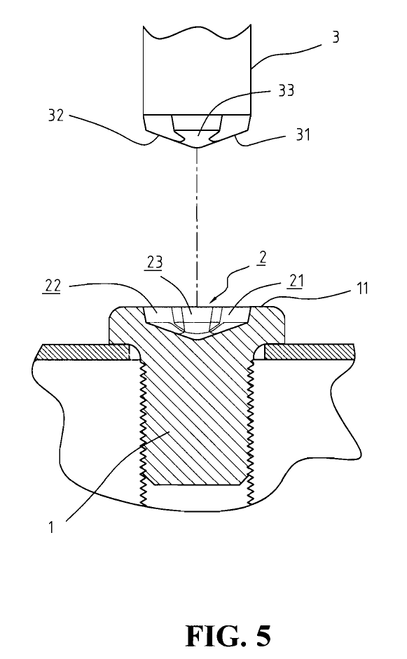

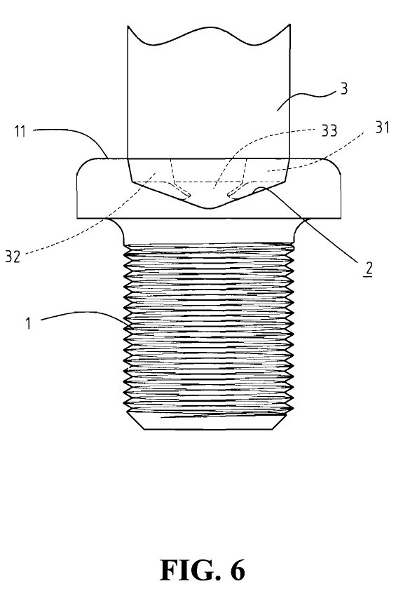

Referring to FIGS. 1, 5 and 6 in conjunction, the situation of the driving tool (3) applying force to a matching recess (2) of the fastener (1) is described. When the driver bits (31) (32) (33) of the driving tool (3) rotates, a forces (F) and a reaction force (F′) are generated at the facets (211) (212) (221) (222) (231) (232) of the lobular grooves (21) (22) (23) on the same central lines (Cl) (C2) (C3). As shown in FIG. 1, when the driving tool (3) rotates anticlockwise, a vertical force (F) exerted on the facet (212) of the lobular groove (21) creates a force couple with a vertical reaction force (F′) on the facet (221) of the lobular groove (22), and since the moment forces created by the facet (212) and another facet (221) are in parallel with and on the same central line (C3), and the same applies to other pairs of facets. As a result, the torque produced by rotating the driving tool (3) can be maximized, and the driving tool (3) can easily anticlockwise unscrew the fastener (1).

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

1. A screw head recess structure, comprising: a recess formed by a plurality of lobular grooves arranged on a head of a rotational fastener, the lobular grooves equiangularly radiating from an axis of the fastener and arranged on a top face of the fastener; facets provided at both sides of each lobular groove that respectively receive forces when the fastener rotates clockwise and anticlockwise, and the facets of corresponding lobular grooves along both sides of central lines being in parallel and on the same central lines.

2. The screw head recess structure of claim 1, wherein the recess includes three sets of lobular grooves arranged in a radiating manner and equiangularly arranged around the axis of the fastener on the top face of the fastener; each groove having a “n” shape and connected to each other forming a three-toe recess configuration; each groove including facets on both sides thereof that respectively receive forces when the fastener rotates clockwise and anticlockwise and an arc-shaped outer sidewall, wherein facets at both sides of a groove tends towards each other as they are closer to the axis of the fastener in such a way that two symmetrical facets from different grooves are in parallel with and on the same central line.

3. The screw head recess structure of claim 2, wherein each lobular groove forming the recess slightly inclines downward from the top face of the fastener towards the central point at the bottom of the recess.

4. The screw head recess structure of claim 2, wherein the depth of the recess is shallower and half that of a traditional fastener recess.

5. A driving tool that is used on the screw head recess structure of claim 1, comprising a matching configuration with the recess of the fastener, comprising a plurality of driver bits matching the lobular grooves of the recess and equiangularly arranged and protruding from a tip of the driving tool, wherein the height of protrusion is substantially equal to the depth of the recess, so that the driver bits can fully insert into the recess for rotational operations.

6. The driving tool of claim 5, wherein the driving tool has a three-lobe driver bit configuration that matches with the three-toe recess configuration of the fastener.
